(19) United States
(12) Patent Application Publication
(10) Pub. No.: US 2002/0081563 A1
(43) Pub. Date: Jun. 27, 2002

(54) Multipurpose pen-holding trainer

(76) Inventor: Jiun Feng You, Taipei (TW)

Correspondence Address: YOU JIUN FENG, P. O. BOX 26-757, TAIPEI, 106, TW

(21) Appl. No.: 09/746,657

(22) Filed: Dec. 22, 2000

(51) Int. Cl. G09B 11/00

(52) U.S. Cl. 434/415

(57) ABSTRACT

The present invention proposes a multipurpose pen-holding trainer, whose shape is roughly triangular. The present invention comprises a main body integrally formed of soft rubber. The main body is a hollow pillar with an opening formed at each of the two ends thereof. The two openings can be penetrated to join a penholder. The main body is fixed at the one-third position of the penholder near the pen point. Triangular positioning points can prevent the user from making trivial actions such as rotating or striking the pen and help the user be accustomed to placing his fingers on the penholder. A plurality of shifting bodies are installed on the triangular surface of the main body to help the user move his fingers for writing so that the problem of untidy chirography of the user due to incorrect pen-holding posture can be avoided.

### FIELD OF THE INVENTION

The present invention relates to a multipurpose pen-holding trainer and, more particularly, to a pen-holding trainer for adjusting the pen-holding posture.

### BACKGROUND OF THE INVENTION

Prior art penholders generally are designed to be cylindrical in consideration of comfort and convenience of the user. However, for preschool children having no pen-holding experiences and knowing no pen-holding methods, cylindrical penholders easily slide and are difficult to control, resulting in difficulty in writing. Moreover, the chirography of the user may be untidy due to longtime incorrect pen-holding posture.

Therefore, the prior art penholders have inconvenience and drawback in practical assembly and use. The present invention aims to resolve the above problems in the prior art.

### SUMMARY OF THE INVENTION

The primary object of the present invention is to provide a multipurpose pen-holding trainer for preschool children having no pen-holding experiences and knowing no pen-holding methods so that the penholder does not easily slide and is easy to control. Therefore, difficulty in writing of preschool children and untidy chirography of the user due to longtime incorrect pen-holding posture can be resolved.

To achieve the above object, the present invention provides a multipurpose pen-holding trainer, which comprises a main body integrally formed of soft rubber. The main body is a hollow pillar with an opening formed at each of the two sides thereof. The two openings can be penetrated to join a penholder. The main body is fixed at one-third position of the penholder near the pen point. Triangular positioning points can prevent the user from making trivial actions such as rotating or striking the pen and help the user be accustomed to placing his fingers on the penholder. A plurality of shifting bodies are installed on the triangular surface of the main body. The shifting bodies can help the user move his fingers for writing so that the problem of untidy chirography of the user due to longtime incorrect pen-holding posture can be avoided.

The various objects and advantages of the present invention will be more readily understood from the following detailed description when read in conjunction with the appended drawings, in which:

### BRIEF DESCRIPTION OF THE DRAWINGS:

FIG. 1 is a plan view of the present invention;

FIG. 2 is an exploded perspective view of the present invention;

FIG. 3 is a perspective view of the present invention;

FIG. 4 is a diagram showing a use state of the present invention;

FIG. 5 is perspective view according to another embodiment of the present invention;

FIG. 6 is an exploded perspective view according to yet another embodiment of the present invention;

FIG. 7 is a plan view according to still yet another embodiment of the present invention;

FIG. 8 is an exploded perspective view according to still yet another embodiment of the present invention;

FIG. 9 is a perspective view according to still yet another embodiment of the present invention; and

FIG. 10 is a view showing the use state according to still yet another embodiment of the present invention.

### DETAILED DESCRIPTION OF THE PREFERRED EMBODIMENTS

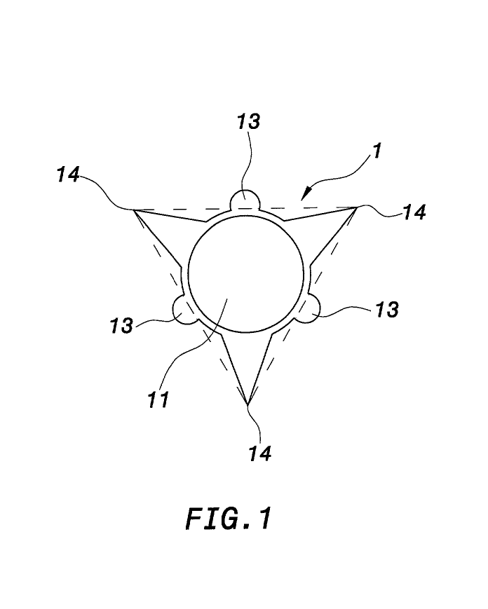

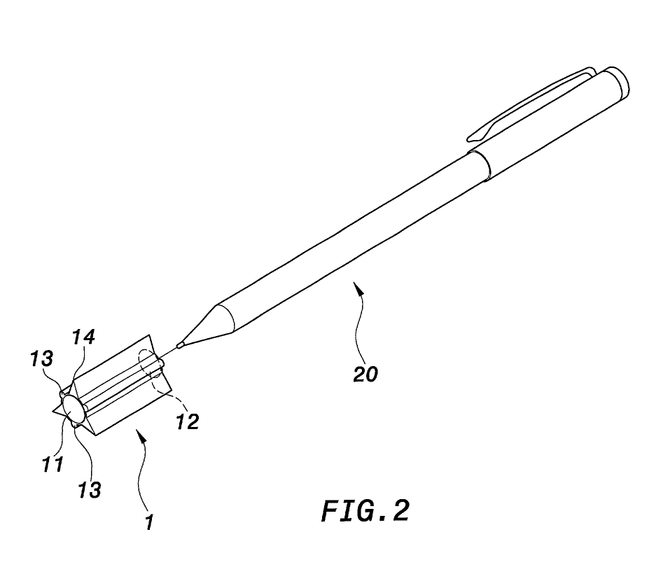

As shown in FIGS. 1 and 2, the present invention relates to a multipurpose pen-holding trainer and, more particularly, to a pen-holding trainer for adjusting the pen-holding posture. The shape of this embodiment of the present invention is roughly triangular. The pen-holding trainer of the present invention comprises a main body 1 integrally formed of soft rubber. The main body 1 is a hollow pillar with two openings 11 and 12 formed at the two ends thereof. The two openings 11 and 12 can be penetrated to connect a penholder 20. The main body 1 is fixed at the one-third position of the penholder 20 near the pen point. Triangular positioning points 14 of the main body 1 can prevent the user from making trivial actions such as rotating or striking the pen and help the user be accustomed to placing his fingers on the penholder 20. A plurality of shifting bodies 13 are installed on the triangular surface of the main body 1. The shifting bodies 13 can help the user move his fingers for writing so that the problem of untidy chirography of the user due to longtime incorrect pen-holding posture can be avoided. The main body 1 also has retractility to be penetrated for joining unspecified penholders 20. Thereby, the object of repetitive use can be achieved.

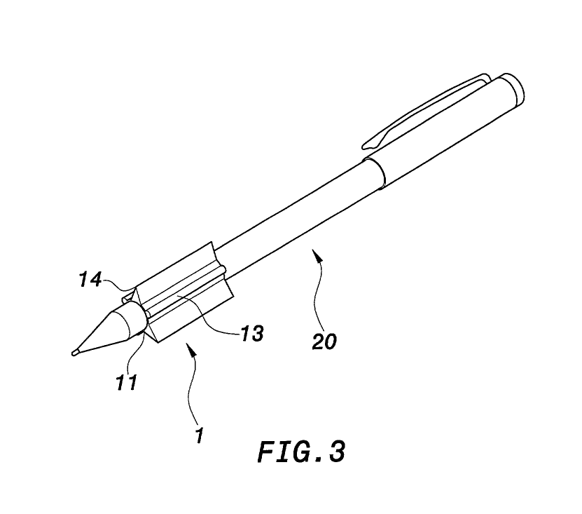

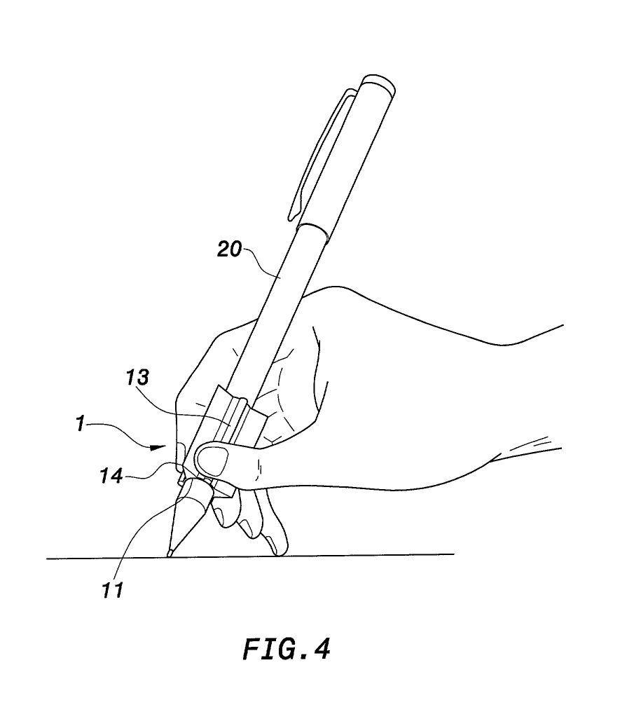

As shown in FIGS. 2 and 3, when the present invention is to be assembled for use, the opening 12 of the main body 1 is first penetrated by the pen point of the penholder 20, the penholder 20 then protrudes out of the opening 11 of the main body 1. Next, the main body 1 is fixed at the one-third position of the penholder 20 near the pen point. The joining of the main body 1 and the penholder 20 is thus finished. As shown in FIG. 4, when a preschool child or a user having incorrect pen-holding posture for a long time wants to use the present invention to practice writing, it is only necessary for him to place the penholder 20 at the arc part between the thumb and the forefinger and place his fingers on the triangular main body 1 and in the triangular positioning points 14 of the main body 1 to prevent him from making trivial actions such as rotating or striking the pen and help him be accustomed to placing his fingers on the penholder 20. Finally, he can start to practice writing after placing his fingertips on the shifting bodies 13. The problem of untidy chirography of the user due to incorrect pen-holding posture can be avoided.

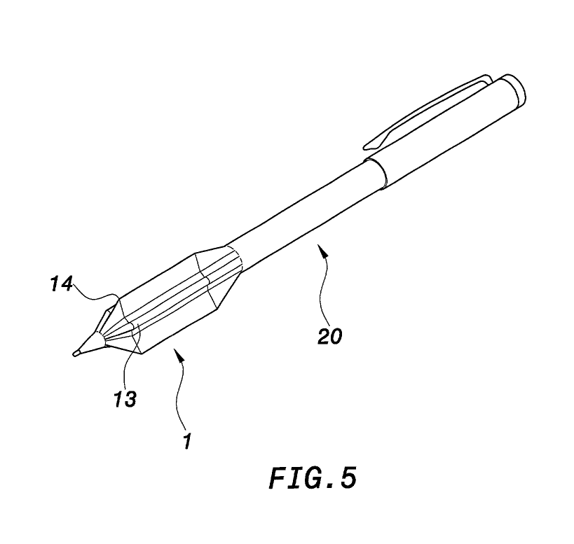

FIG. 5 shows another embodiment of the present invention, wherein a main body 1 and a penholder 20 are integrally formed. The main body 1 also joins a specific penholder 20. The main body 1 is roughly shuttle-shaped. The main body 1 is fixed at the one-third position of the penholder 20 near the pen point. Triangular positioning points 14 of the main body 1 can prevent the user from making trivial actions such as rotating or striking the pen and help him be accustomed to placing his fingers on the penholder. A plurality of shifting bodies 13 are installed on the triangular surface of the main body 1. The shifting bodies 13 can help the user move his fingers for writing so that the problem of untidy chirography of the user due to incorrect pen-holding posture can be avoided.

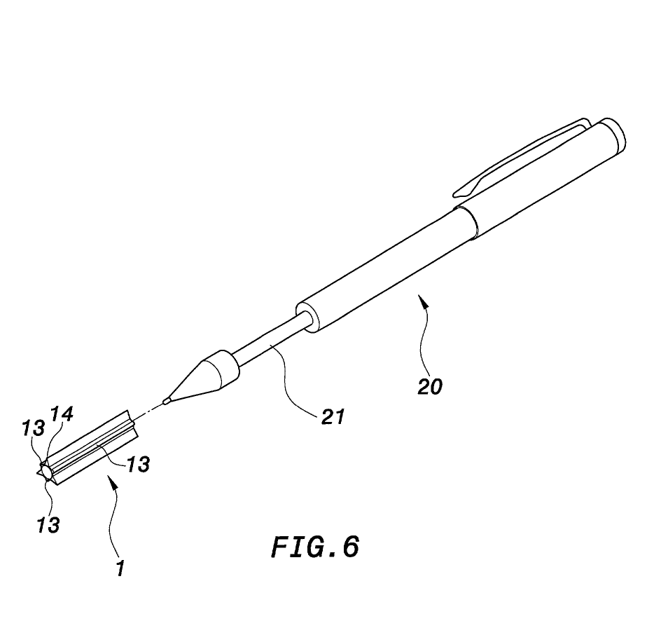

FIG. 6 shows yet another embodiment of the present invention, wherein a groove 21 is formed at the one-third position of the penholder 20 near the pen point. The groove 21 can join a specific main body 1. The shape of the main body 1 of this embodiment is roughly triangular. Triangular positioning points 14 of the main body 1 can prevent the user from making trivial actions such as rotating or striking the pen and help him be accustomed to placing his fingers on the penholder. A plurality of shifting bodies 13 are installed on the triangular surface of the main body 1. The shifting bodies 13 can help the user move his fingers for writing so that the problem of untidy chirography of the user due to incorrect pen-holding posture can be avoided.

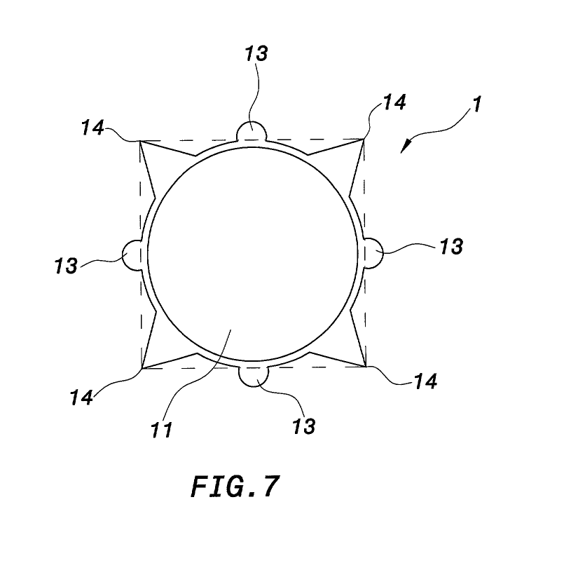

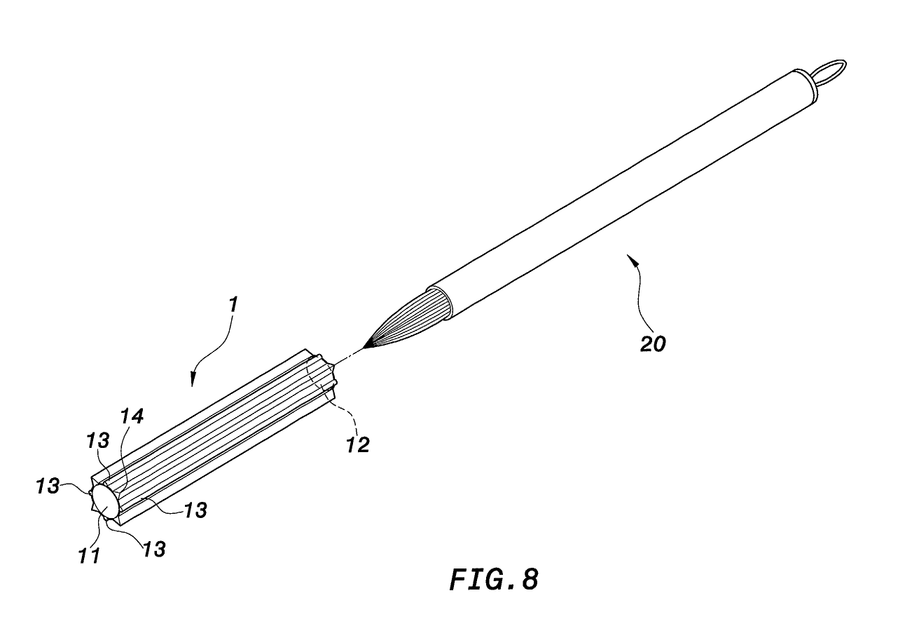

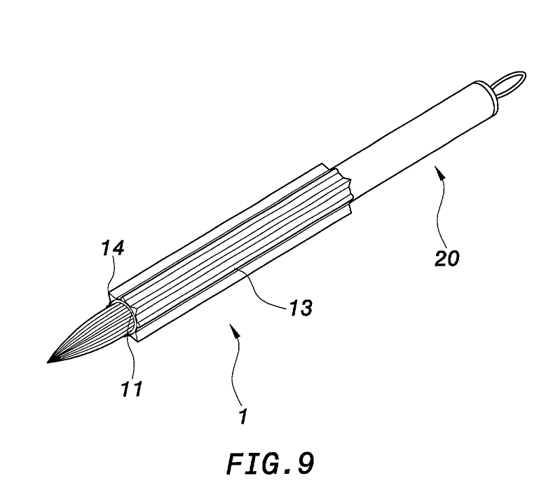

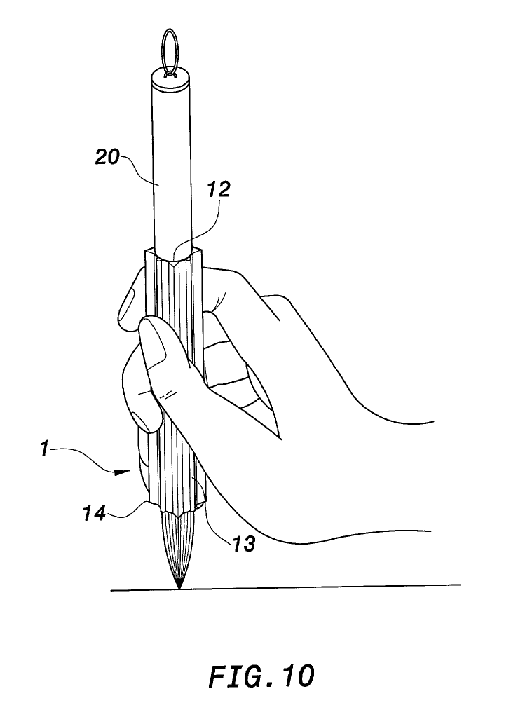

FIGS. 7 to 10 show still yet another embodiment of the present invention. The main body 1 of this embodiment is penetrated to join the penholder 20 of a hair pencil. The shape of this embodiment is roughly rectangular to help the user be accustomed to placing his fingers on the penholder. This embodiment comprises a main body 1 integrally formed of soft rubber. The main body 1 is a hollow pillar with openings 11 and 12 formed at the two ends thereof. The two openings 11 and 12 can be penetrated to join a penholder 20 of a hair pencil. One end of the main body 1 is fixed at the one-half position of the penholder 20, while the other end thereof is fixed at a position of the penholder near the pen point. Triangular positioning points 14 of the rectangular main body 1 can prevent the user from making trivial actions such as rotating or striking the pen and help the user be accustomed to placing his fingers on the penholder 20. A plurality of shifting bodies 13 are installed on the triangular surface of the main body 1. The shifting bodies 13 can help the user move his fingers for writing so that the problem of untidy chirography of the user due to incorrect pen-holding posture can be avoided. The main body 1 also has retractility to be penetrated for joining a unspecified penholder 20 of a hair pencil. Thereby, the object of repetitive use can be achieved.

To sum up, the present invention provides a multipurpose pen-holding trainer for preschool children having no pen-holding experiences and knowing no pen-holding methods so that the penholder does not easily slide and is easy to control. Therefore, difficulty in writing of preschool children and untidy chirography of the user due to incorrect pen-holding posture can be resolved.

Although the present invention has been described with reference to the preferred embodiments thereof, it will be understood that the invention is not limited to the details thereof. Various substitutions and modifications have been suggested in the foregoing description, and others will occur to those of ordinary skill in the art. Therefore, all such substitutions and modifications are intended to be embraced within the scope of the invention as defined in the appended claims.

I claim:

1. A multipurpose pen-holding trainer comprising
a main body, said main body being a hollow pillar with an openings formed at each of the two ends thereof, said two openings being penetrated to join a penholder, a plurality of positioning points and shifting bodies being installed on the surface of said body for the positioning and shifting of fingers.

2. The multipurpose pen-holding trainer as claimed in claim 1, wherein said main body is made of soft rubber.

3. The multipurpose pen-holding trainer as claimed in claim 1, wherein said main body is formed as an integral body.

4. The multipurpose pen-holding trainer as claimed in claim 1, wherein said main body and said penholder are formed as an integral body

5. The multipurpose pen-holding trainer as claimed in claim 1, wherein the shape of said main body can be triangular or rectangular.
